(19) United States
(12) Patent Application Publication
(10) Pub. No.: US 2026/0092940 A1
(43) Pub. Date: Apr. 2, 2026

(54) Sensor Module

(71) Applicant: SEIKO EPSON CORPORATION, Tokyo (JP)

(72) Inventors: Taketo CHINO, Hokuto (JP); Yoshikuni SAITO, Kofu (JP); Masayasu SAKUMA, Shiojiri (JP)

(21) Appl. No.: 19/341,162

(22) Filed: Sep. 26, 2025

(30) Foreign Application Priority Data
Sep. 27, 2024 (JP) 2024-169479

(51) Int. Cl. G01P 1/02; G01P 3/42

(52) U.S. Cl. CPC G01P 1/026; G01P 3/42

(57) ABSTRACT

A sensor module includes a sensor substrate including a circuit substrate and an inertial sensor mounted on the circuit substrate, a package including a main body portion having a first surface and a second surface in a front-back relationship and a side surface coupling the first surface and the second surface and housing the sensor substrate inside, and a flexible wiring portion electrically coupled to the sensor substrate and extending from the side surface to an outside of the package, wherein the package has a first screw insertion hole penetrating the first surface and the second surface, and is fixed to an object by a screw inserted through the first screw insertion hole.

The present application is based on, and claims priority from JP Application Serial Number 2024-169479, filed September 27, 2024, the disclosure of which is hereby incorporated by reference herein in its entirety.

### BACKGROUND

### 1. Technical Field

The present disclosure relates to a sensor module.

### 2. Related Art

An inertial measurement device described in JP-A-2019-163955 includes an inner case, a circuit substrate mounted on a lower surface of the inner case, and an outer case that covers the inner case and houses the circuit substrate between the inner case and itself. A Z-axis angular velocity sensor, a triaxial acceleration sensor, and a plug-type connector are mounted on an upper surface of the circuit substrate, a microcontroller is mounted on a lower surface of the circuit substrate, and an X-axis angular velocity sensor and a Y-axis angular velocity sensor are mounted on side surfaces of the circuit substrate.

JP-A-2019-163955 is an example of the related art.

However, in the inertial measurement device in JP-A-2019-163955, since the plug-type connector is disposed in a standing attitude with respect to the circuit substrate, it is difficult to reduce the height of the entire device.

### SUMMARY

A sensor module according to an aspect of the present disclosure includes a sensor substrate including a circuit substrate and an inertial sensor mounted on the circuit substrate, a package including a main body portion having a first surface and a second surface in a front-back relationship and a side surface coupling the first surface and the second surface and housing the sensor substrate inside, and a flexible wiring portion electrically coupled to the sensor substrate and extending from the side surface to an outside of the package, wherein the package has a first screw insertion hole penetrating the first surface and the second surface, and is fixed to an object by a screw inserted through the first screw insertion hole.

### BRIEF DESCRIPTION OF THE DRAWINGS

FIG. 1 is a perspective view showing a sensor module according to a first embodiment.

FIG. 2 is an exploded perspective view of the sensor module.

FIG. 3 is a bottom view of the sensor module.

FIG. 4 is a top view of a sensor substrate.

FIG. 5 is a cross-sectional view of an acceleration sensor.

FIG. 6 is a plan view showing an angular velocity sensor.

FIG. 7 is a schematic diagram showing a driving state of the angular velocity sensor.

FIG. 8 is a schematic diagram showing a driving state of the angular velocity sensor.

FIG. 9 is a cross-sectional view showing a mounting state of the sensor module.

FIG. 10 is a top view showing a modification of a flexible wiring portion.

FIG. 11 is a top view showing a modification of the flexible wiring portion.

FIG. 12 is a perspective view of a sensor module according to a second embodiment.

FIG. 13 is a cross-sectional view of the sensor module.

FIG. 14 is a cross-sectional view of a sensor module according to a third embodiment.

FIG. 15 is a perspective view of a sensor module according to a fourth embodiment.

FIG. 16 is a bottom view of the sensor module.

FIG. 17 is a bottom view showing a modification of the sensor module.

FIG. 18 is a bottom view showing a modification of the sensor module.

FIG. 19 is a top view of a sensor module according to a fifth embodiment.

FIG. 20 is a cross-sectional view of the sensor module.

FIG. 21 is a top view showing a modification of the sensor module.

FIG. 22 is a top view of a sensor module according to a sixth embodiment.

FIG. 23 is a top view showing a modification of the sensor module.

FIG. 24 is a cross-sectional view showing a modification of the sensor module.

### DESCRIPTION OF EMBODIMENTS

Hereinafter, a sensor module of the present disclosure will be described in detail based on embodiments shown in the accompanying drawings. Note that, for convenience of description, three axes orthogonal to one another are shown as an X axis, a Y axis, and a Z axis in the respective drawings. Further, hereinafter, for convenience of description, a direction parallel to the X axis is also referred to as "X-axis direction", a direction parallel to the Y axis is also referred to as "Y-axis direction", and a direction parallel to the Z axis is also referred to as "Z-axis direction". A side indicated by an arrowhead on each axis is also referred to as a "positive side", and an opposite side is also referred to as a "negative side". Further, the arrowhead side in the Z-axis direction is also referred to as "upper", and the opposite side is also referred to as "lower".

### First Embodiment

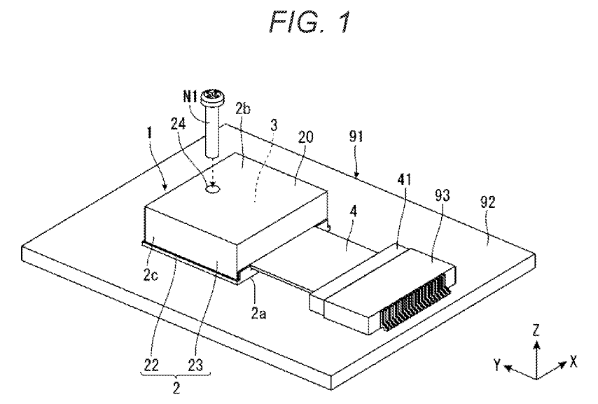

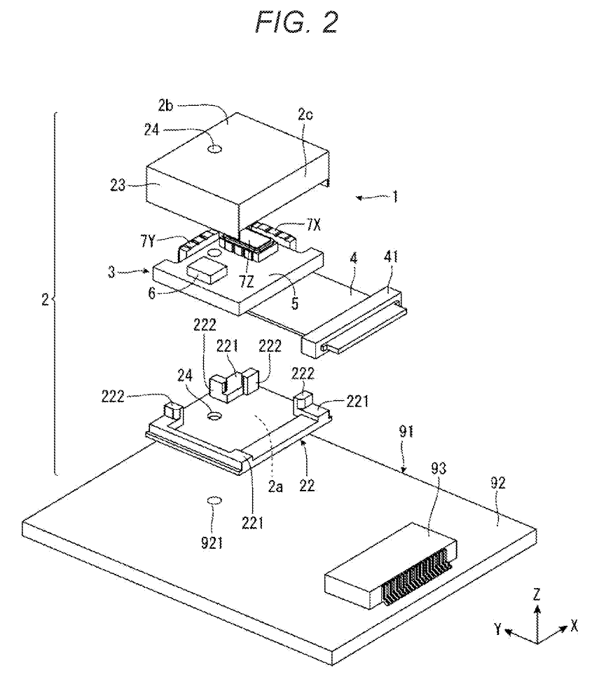

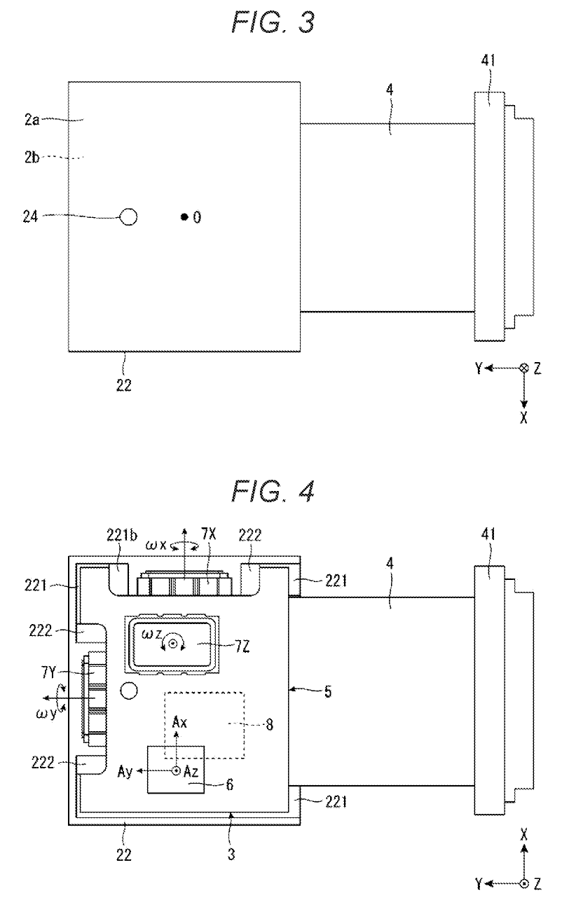

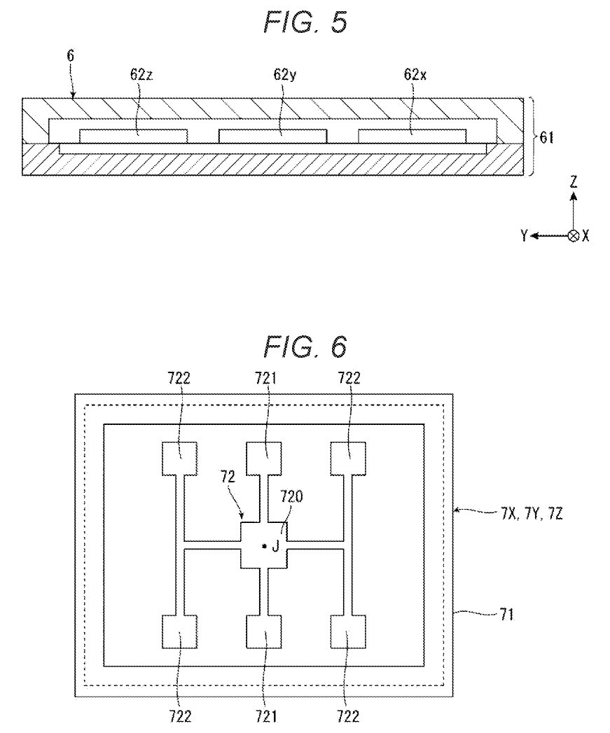

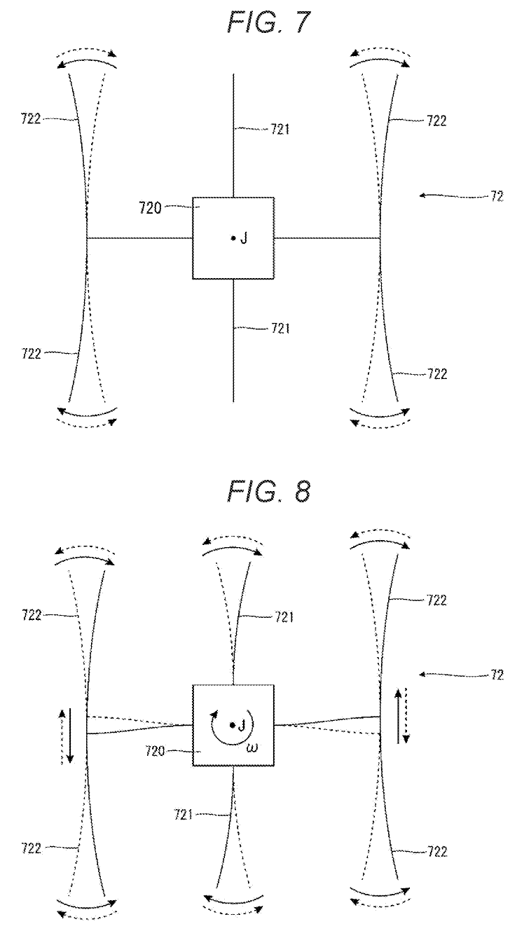

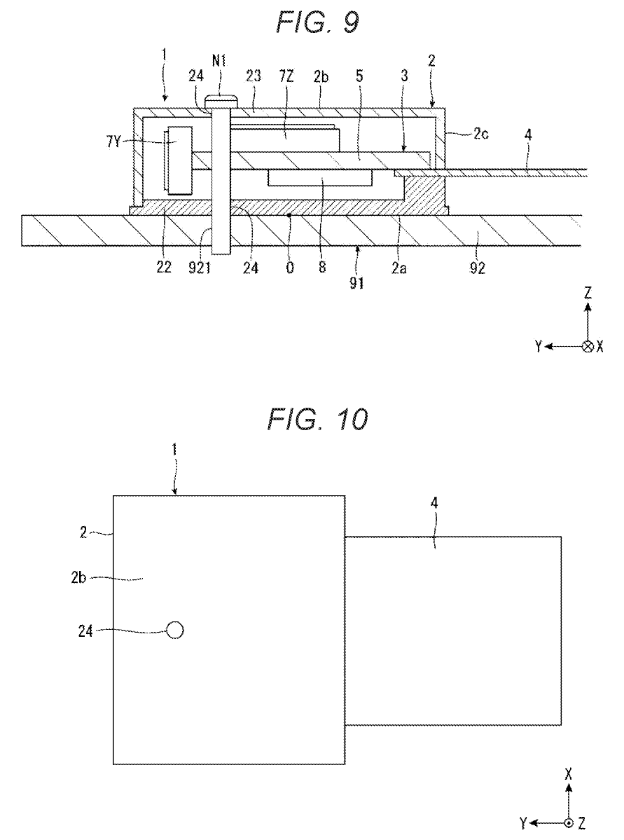

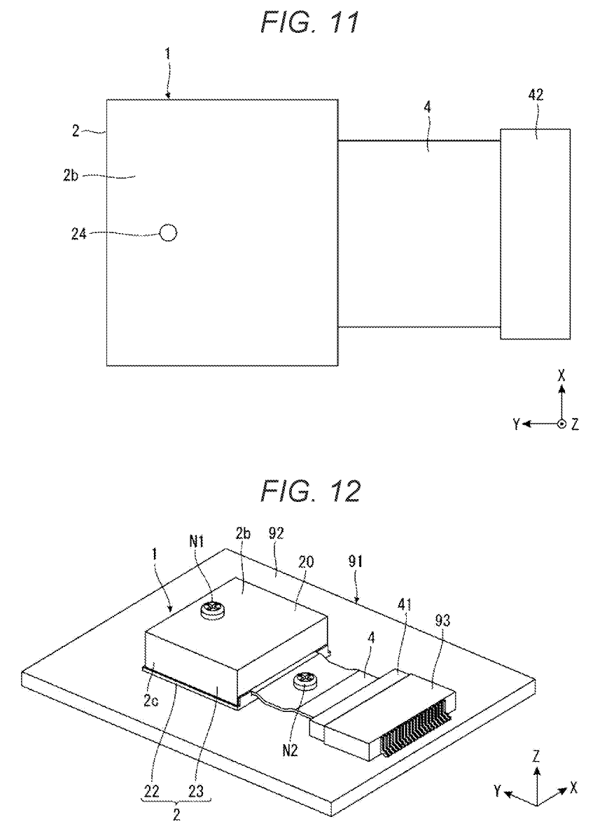

FIG. 1 is a perspective view showing a sensor module according to a first embodiment. FIG. 2 is an exploded perspective view of the sensor module. FIG. 3 is a bottom view of the sensor module. FIG. 4 is a top view of a sensor substrate. FIG. 5 is a cross-sectional view of an acceleration sensor. FIG. 6 is a plan view showing an angular velocity sensor. FIGS. 7 and 8 are respectively schematic diagrams showing driving states of an angular velocity sensor. FIG. 9 is a cross-sectional view showing a mounting state of the sensor module. FIGS. 10 and 11 are respectively top views showing modifications of a flexible wiring portion.

A sensor module 1 illustrated in FIG. 1 is an inertial measurement sensor unit (IMU: Inertial Measurement Unit) that independently measures an angular velocity around each axis of the X axis, the Y axis, and the Z axis and an acceleration in each axis direction of the X axis, the Y axis, and the Z axis. The sensor module 1 includes a package 2, a sensor substrate 3 housed in the package 2, and a flexible wiring portion 4 electrically coupled to the sensor substrate 3 and extending out from the package 2.

### Package 2

As illustrated in FIG. 1, the package 2 includes a main body portion 20 having a housing space for housing the sensor substrate 3 inside. The main body portion 20 has a cubic shape, and has a lower surface 2a as a first surface and an upper surface 2b as a second surface in a front-back relationship, and a frame-shaped side surface 2c coupling the lower surface 2a and the upper surface 2b. Since the lower surface 2a is formed along an X-Y plane, a "plan view from the Z-axis direction" frequently used below is synonymous with a "plan view of the lower surface 2a".

As illustrated in FIG. 2, the package 2 includes an inner case 22 and an outer case 23. The outer case 23 covers the inner case 22 from above. In the package 2, the inner case 22 forms the lower surface 2a, and the outer case 23 forms the upper surface 2b.

The inner case 22 and the outer case 23 are respectively formed using aluminum (Al). Thereby, the package 2 having higher rigidity is obtained. In particular, in the present embodiment, alumite treatment is respectively performed on the surfaces of the inner case 22 and the outer case 23 to isolate the package 2. The constituent material of the inner case 22 and the outer case 23 is not particularly limited, but, for example, a metal material such as titanium, magnesium, or stainless steel, or ceramics such as alumina or titania may be used.

The inner case 22 has mount parts 221 erected along an edge thereof, on which the sensor substrate 3 is mounted. Further, the inner case 22 includes a plurality of positioning protrusions 222 that are erected so as to protrude toward the upper side than the mount parts 221 and position the sensor substrate 3 with respect to the mount parts 221.

The outer case 23 is a rectangular parallelepiped box having a recess that opens to the lower surface. The outer case 23 covers the inner case 22 from above by inserting the inner case 22 into the recess. The inner case 22 and the outer case 23 are bonded and fixed by an adhesive (not shown). The method of fixing the inner case 22 and the outer case 23 is not particularly limited, but may be, for example, fixing by screwing.

As shown in FIG. 3, the package 2 has a first screw insertion hole 24 penetrating the lower surface 2a and the upper surface 2b. A screw N1 for fixing the sensor module 1 to a mounting board 91 is inserted into the first screw insertion hole 24. The first screw insertion hole 24 is located at the positive side in the Y-axis direction with respect to a center O of the lower surface 2a. That is, the first screw insertion hole 24 is disposed at the side opposite to the flexible wiring portion 4 with respect to the center O.

Although the package 2 has been described above, the configuration of the package 2 is not particularly limited.

### Sensor Substrate 3

As shown in FIG. 4, the sensor substrate 3 includes a circuit substrate 5, an acceleration sensor 6, an X-axis angular velocity sensor 7X, a Y-axis angular velocity sensor 7Y, and a Z-axis angular velocity sensor 7Z as inertial sensors, and a circuit element 8.

The circuit substrate 5 includes, for example, a rigid substrate such as a multilayer glass epoxy substrate. The lower surface of the circuit substrate 5 is fixed to the upper surfaces of the mount parts 221 via an adhesive (not shown). The method of fixing the circuit substrate 5 to the upper surfaces of the mount parts 221 is not particularly limited, and may be, for example, fixing by screwing. A hole for allowing the screw N1 to be inserted into the first screw insertion hole 24 is formed in a portion of the circuit substrate 5 overlapping the first screw insertion hole 24.

As shown in FIG. 4, the acceleration sensor 6 is mounted on the upper surface of the circuit substrate 5 so as to face the positive side in the Z-axis direction. The acceleration sensor 6 is a three-axis acceleration sensor that can independently detect an acceleration Ax in the X-axis direction, an acceleration Ay in the Y-axis direction, and an acceleration Az in the Z-axis direction.

As illustrated in FIG. 5, the acceleration sensor 6 includes a package 61 and sensor elements 62x, 62y, and 62z housed in the package 61. The acceleration sensor is electrically coupled to the circuit substrate 5 via a coupling terminal (not shown) disposed in the package 61.

The sensor element 62x is an element that detects the acceleration Ax in the X-axis direction, the sensor element 62y is an element that detects the acceleration Ay in the Y-axis direction, and the sensor element 62z is an element that detects the acceleration Az in the Z-axis direction. Although not illustrated, the sensor elements 62x, 62y, and 62z are silicon MEMS vibrator elements having fixed electrodes fixed to the package 61 and movable electrodes variable with respect to the package 61. In the sensor elements 62x, 62y, and 62z, when the acceleration in the detection axis direction is applied, the movable electrode is displaced with respect to the fixed electrode, and accordingly, the capacitance formed between the fixed electrode and the movable electrode changes. Thus, the changes in the capacitance of the sensor elements 62x, 62y, and 62z can be extracted as detection signals and the accelerations in the respective axis directions can be obtained based on the extracted detection signals.

The acceleration sensor 6 has been described above, however, the configuration of the acceleration sensor 6 is not particularly limited. For example, as the sensor elements 62x, 62y, and 62z, quartz crystal vibrator elements may be used.

As shown in FIG. 4, the X-axis angular velocity sensor 7X is mounted on the side surface of the circuit substrate 5 so as to face the positive side in the X-axis direction. The X-axis angular velocity sensor 7X detects an angular velocity ωx around the X axis. The Y-axis angular velocity sensor 7Y is mounted on the side surface of the circuit substrate 5 so as to face the positive side in the Y-axis direction. The Y-axis angular velocity sensor 7Y detects an angular velocity ωy around the Y axis. The Z-axis angular velocity sensor 7Z is mounted on the upper surface of the circuit substrate 5 so as to face the positive side in the Z-axis direction. The Z-axis angular velocity sensor 7Z detects an angular velocity ωz around the Z axis.

As shown in FIG. 6, each of the X-axis angular velocity sensor 7X, the Y-axis angular velocity sensor 7Y, and the Z-axis angular velocity sensor 7Z includes a package 71 and a sensor element 72 housed in the package 71. The sensors are electrically coupled to the circuit substrate 5 via a coupling terminal (not shown) disposed in the package 71.

The sensor element 72 is, for example, a quartz crystal vibrator element, and includes a base portion 720, four drive vibration arms 722, and two detection vibration arms 721. In the sensor element 72, as shown in FIG. 7, when an angular velocity ω around a detection axis J is applied while the drive vibration arms 722 are drive-vibrated by application of a drive signal, as shown in FIG. 8, detection vibration is excited in the detection vibration arms 721 by the Coriolis force. The electric charge generated in the detection vibration arms 721 by the detection vibration is extracted as a detection signal, and the angular velocity ω can be obtained based on the extracted detection signal.

The configurations of the X-axis angular velocity sensor 7X, the Y-axis angular velocity sensor 7Y, and the Z-axis angular velocity sensor 7Z have been collectively described above. The X-axis angular velocity sensor 7X is disposed such that the detection axis J is along the X axis, the Y-axis angular velocity sensor 7Y is disposed such that the detection axis J is along the Y axis, and the Z-axis angular velocity sensor 7Z is disposed such that the detection axis J is along the Z axis. Accordingly, the angular velocity ωx can be detected by the X-axis angular velocity sensor 7X, the angular velocity ωy can be detected by the Y-axis angular velocity sensor 7Y, and the angular velocity ωz can be detected by the Z-axis angular velocity sensor 7Z.

The configurations of the X-axis angular velocity sensor 7X, the Y-axis angular velocity sensor 7Y, and the Z-axis angular velocity sensor 7Z are not particularly limited. For example, a silicon MEMS vibration element may be used as the sensor element 72.

As shown in FIG. 4, the circuit element 8 is mounted on the lower surface of the circuit substrate 5. The circuit element 8 is electrically coupled to the acceleration sensor 6, the X-axis angular velocity sensor 7X, the Y-axis angular velocity sensor 7Y, and the Z-axis angular velocity sensor 7Z via the circuit substrate 5. The circuit element 8 is, for example, an MCU (Micro Controller Unit), and performs integrated control of the respective portions of the sensor module 1. Specifically, the circuit element 8 includes a control circuit that controls driving of the acceleration sensor 6, the X-axis angular velocity sensor 7X, the Y-axis angular velocity sensor 7Y, and the Z-axis angular velocity sensor 7Z via the circuit substrate 5, and an interface circuit that communicates with the outside.

The control circuit controls driving of the acceleration sensor 6, the X-axis angular velocity sensor 7X, the Y-axis angular velocity sensor 7Y, and the Z-axis angular velocity sensor 7Z, detects the accelerations Ax, Ay, and Az based on the detection signal output from the acceleration sensor 6, and detects the angular velocities ωx, ωy, and ωz based on the detection signals output from the X-axis, Y-axis, and Z-axis angular velocity sensors 7X, 7Y, and 7Z. The interface circuit transmits and receives signals, receives commands from the outside, and outputs the detected accelerations Ax, Ay, and Az and the detected angular velocities ωx, ωy, and ωz to the outside.

The sensor substrate 3 has been described above, however, the configuration of the sensor substrate 3 is not particularly limited. For example, in the present embodiment, the acceleration sensor 6, the X-axis angular velocity sensor 7X, the Y-axis angular velocity sensor 7Y, and the Z-axis angular velocity sensor 7Z are provided as the inertial sensors, however, the present disclosure is not limited thereto, and at least one inertial sensor may be provided.

### Flexible Wiring Portion 4

As shown in FIGS. 2 and 4, the flexible wiring portion 4 is electrically coupled to the circuit substrate 5, and has a function of electrically coupling the circuit substrate 5 to the mounting board 91. The flexible wiring portion 4 is wiring having flexibility, and includes, for example, a flexible substrate. In particular, in the present embodiment, the circuit substrate 5 and the flexible wiring portion 4 are integrally formed using a rigid flexible substrate in which a rigid substrate serving as the circuit substrate 5 and a flexible substrate serving as the flexible wiring portion 4 are coupled. Accordingly, the device configuration of the sensor module 1 is simplified. In addition, since the circuit substrate 5 and the flexible wiring portion 4 can be coupled without using a component such as a connector, the number of components can be reduced, and the sensor module 1 can be reduced in size, weight, and the like.

The flexible wiring portion 4 is coupled to an end of the circuit substrate 5 at the negative side in the Y-axis direction, and extends to the outside of the package 2 from a surface facing the negative side in the Y-axis direction of the side surface 2c of the main body portion 20. A connector 41 is attached to a free end of the flexible wiring portion 4, and the flexible wiring portion is coupled to an external device via the connector 41.

The configuration of the sensor module 1 has been described above. The sensor module 1 is mounted on the mounting board 91 as shown in FIG. 9. The mounting board 91 includes a circuit substrate 92 and a connector 93 mounted on the upper surface of the circuit substrate 92. A screw hole 921 for fastening the screw N1 is formed in the circuit substrate 92.

First, the connector 41 provided in the flexible wiring portion 4 is coupled to the connector 93 of the mounting board 91. Accordingly, the sensor module 1 and the mounting board 91 are electrically coupled to each other. Then, the sensor module 1 is placed on the upper surface of the circuit substrate 92 in an attitude in which the lower surface 2a faces the mounting board 91 side. Then, the sensor module 1 is fixed to the circuit substrate 92 by fastening the screw N1 inserted through the first screw insertion holes 24 formed in the package 2 to the screw holes 921.

Thus, the mounting of the sensor module 1 on the mounting board 91 is completed. As described above, the sensor module 1 is electrically coupled to the mounting board 91 via the flexible wiring portion 4. Therefore, it is not necessary to mount a connector on the circuit substrate 5 as in the related art. Further, in the sensor module 1, the flexible wiring portion 4 extends to the outside from the side surface 2c of the package 2. According to the configuration, since a connector is not required inside and the flexible wiring portion 4 does not protrude upward and downward from the package 2, the height of the sensor module 1 can be reduced.

In particular, in the present embodiment, the first screw insertion hole 24 is disposed at the side opposite to the flexible wiring portion 4 with respect to the center O of the lower surface 2a. That is, the flexible wiring portion 4 is disposed at the negative side of the center O in the Y-axis direction, whereas the first screw insertion hole 24 is disposed at the positive side of the center O in the Y-axis direction. According to the configuration, the two fixing points (the connector 41 and the screw N1) fixed to the mounting board 91 can be separated as much as possible, and the mounting stability of the sensor module 1 is increased.

In the present embodiment, the connector 41 attached to the end part of the flexible wiring portion 4 is electrically coupled to the connector 93 of the mounting board 91, but the present disclosure is not limited thereto. For example, as illustrated in FIG. 10, the connector 41 may be omitted from the end part of the flexible wiring portion 4, and the end part of the flexible wiring portion 4 may be directly coupled to the connector 93. Further, as shown in FIG. 11, a rigid substrate 42 may be disposed in the end part of the flexible wiring portion 4 instead of the connector 41, and the rigid substrate 42 may be coupled to the connector 93.

The sensor module 1 has been described above. As described above, the sensor module 1 includes the circuit substrate 5, the sensor substrate 3 including the acceleration sensor 6, the X-axis angular velocity sensor 7X, the Y-axis angular velocity sensor 7Y, and the Z-axis angular velocity sensor 7Z as the inertial sensors mounted on the circuit substrate 5, the package 2 including the main body portion 20 having the lower surface 2a as the first surface and the upper surface 2b as the second surface in the front-back relationship and the side surface 2c coupling the lower surface 2a and the upper surface 2b, and housing the sensor substrate 3 inside, and the flexible wiring portion 4 electrically coupled to the sensor substrate 3 and extending from the side surface 2c to the outside of the package 2. The package 2 has the first screw insertion hole 24 penetrating the lower surface 2a and the upper surface 2b, and is fixed to the mounting board 91 as an object by the screw N1 inserted through the first screw insertion hole 24. According to the configuration, the sensor module 1 can be electrically coupled to the mounting board 91 via the flexible wiring portion 4. Therefore, it is not necessary to mount a connector on the circuit substrate 5 as in the related art. As described above, it is not necessary to mount the connector on the circuit substrate 5, further, the flexible wiring portion 4 is extended from the side surface 2c of the package 2 to the outside, and thus the height of the sensor module 1 can be reduced.

Further, as described above, the circuit substrate 5 and the flexible wiring portion 4 are configured using the rigid flexible substrate having the rigid substrate as the circuit substrate 5 and the flexible substrate as the flexible wiring portion 4. According to the configuration, the device configuration of the sensor module 1 is simplified. In addition, since the circuit substrate 5 and the flexible wiring portion 4 can be electrically coupled to each other without using a component such as a connector, the number of components can be reduced, and the sensor module 1 can be reduced in height, weight, and the like.

As described above, in the plan view of the lower surface 2a, the first screw insertion hole 24 is disposed at the side opposite to the flexible wiring portion 4 with respect to the center O of the lower surface 2a. According to the configuration, the two fixing points fixed to the mounting board 91 can be separated as much as possible, and the mounting stability of the sensor module 1 is increased.

### Second Embodiment

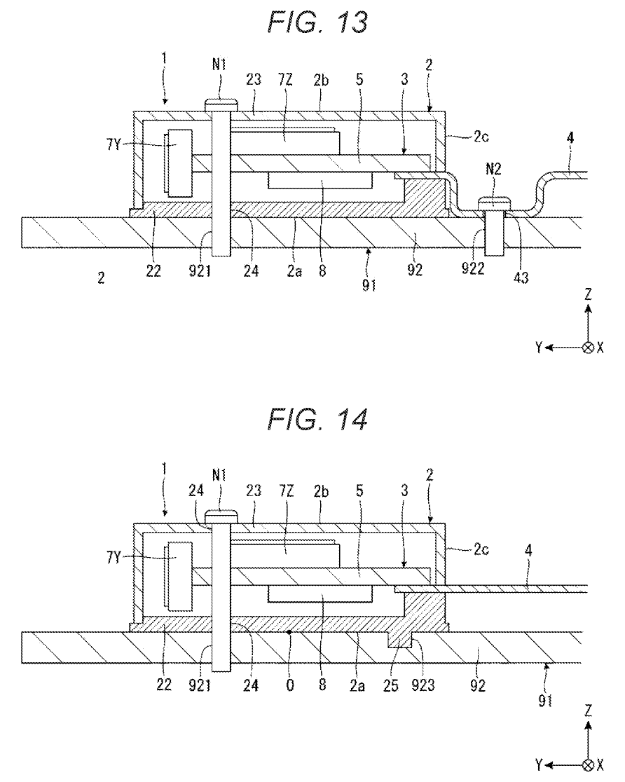

FIG. 12 is a perspective view of a sensor module according to a second embodiment. FIG. 13 is a cross-sectional view of the sensor module.

The sensor module 1 of the present embodiment is the same as that of the first embodiment described above except that the configuration of the flexible wiring portion 4 is different. In the following description, the present embodiment will be described with a focus on the differences from the above-described first embodiment, and the description of the same matters will be omitted. In the respective drawings of the present embodiment, the same configurations as those in the above-described embodiment have the same signs.

As shown in FIGS. 12 and 13, in the sensor module 1 of the present embodiment, a second screw insertion hole 43 through which a screw N2 is inserted is formed in the flexible wiring portion 4. Further, in the mounting board 91, a screw hole 922 into which the screw N2 is screwed is formed in the circuit substrate 92.

In the sensor module 1 having the configuration, as shown in FIG. 13, after the sensor module 1 is mounted on the mounting board 91 in the same manner as in the first embodiment described above, the sensor module 1 is fixed to the circuit substrate 92 by fastening the screw N2 inserted through the second screw insertion holes 43 to the screw hole 922. According to the configuration, since the sensor module 1 is fixed to the mounting board 91 by the two screws N1 and N2, the mounting stability of the sensor module 1 is increased. Further, since the flexible wiring portion 4 is fixed to the mounting board 91 by the screw N2, unnecessary vibration of the flexible wiring portion 4 can be effectively suppressed.

As described above, in the sensor module 1 of the present embodiment, the flexible wiring portion 4 has the second screw insertion hole 43 and is fixed to the mounting board 91 as the object by the screw N2 inserted through the second screw insertion hole 43. According to the configuration, the mounting stability of the sensor module 1 is increased. Further, since the flexible wiring portion 4 is fixed to the mounting board 91 by the screw N2, unnecessary vibration of the flexible wiring portion 4 can be effectively suppressed.

According to the second embodiment, the same effects as those in the above-described first embodiment can still be exerted.

### Third Embodiment

FIG. 14 is a cross-sectional view showing a sensor module according to a third embodiment.

The sensor module 1 of the present embodiment is the same as that of the first embodiment described above except that the configuration of the package 2 is different. In the following description, the present embodiment will be described with a focus on the differences from the above-described first embodiment, and the description of the same matters will be omitted. In the drawings of the embodiment, the same configurations as those of the above-described embodiments have the same signs.

As shown in FIG. 14, the package 2 has a columnar convex portion 25 protruding from the lower surface 2a. Further, the convex portion 25 is located at the negative side in the Y-axis direction with respect to the center O of the lower surface 2a. That is, the convex portion 25 is disposed at a side opposite to the first screw insertion hole 24 with respect to the center O. Further, the circuit substrate 92 of the mounting board 91 has a concave portion 923 with a bottom into which the convex portion 25 is fitted.

The sensor module 1 having the configuration is fixed to the circuit substrate 92 by engaging the convex portion 25 of the package 2 with the concave portion 923 and fastening the screw N1 inserted through the first screw insertion hole 24 to the screw hole 921. As described above, by engaging the convex portion 25 with the concave portion 923, the attitude of the sensor module 1 becomes more stable. In addition, since the number of the screws N1 used for fixing can be suppressed to one as in the first embodiment described above, it is easy to mount the sensor module 1 on the mounting board 91. In particular, as in the present embodiment, by disposing the convex portion 25 at the negative side in the Y-axis direction with respect to the center O, the first screw insertion hole 24 and the convex portion 25 can be separated as much as possible. Therefore, the attitude of the sensor module 1 becomes even more stable.

As described above, in the sensor module 1 of the present embodiment, the package 2 has the convex portion 25 protruding from the lower surface 2a, and the convex portion 25 engages with the concave portion 923 formed in the mounting board 91. According to the configuration, the attitude of the sensor module 1 becomes more stable. In addition, since the number of screws N1 used for fixing can be suppressed to be smaller, it is easy to mount the sensor module 1 on the mounting board 91.

According to the third embodiment, the same effects as those of the above-described first embodiment can be exerted. However, for example, the position and the number of the convex portions 25 are not particularly limited.

### Fourth Embodiment

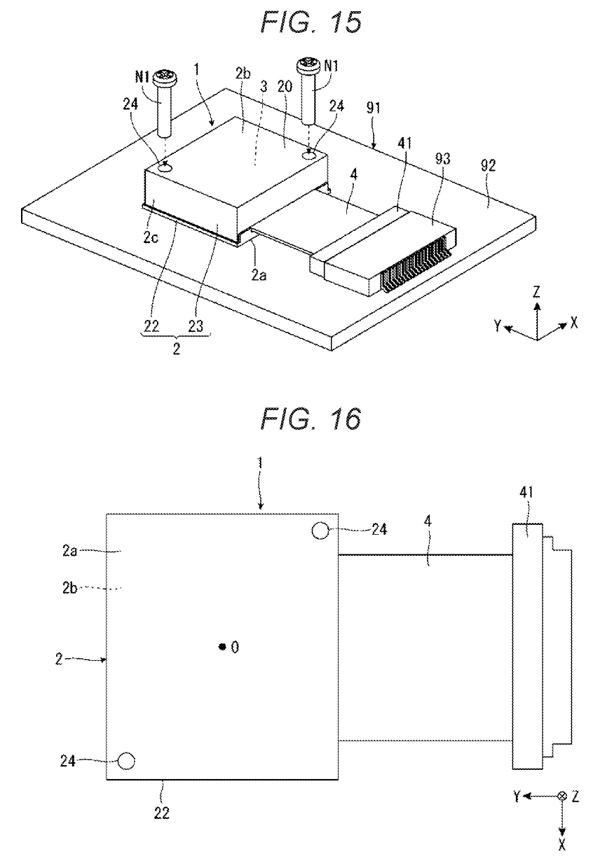

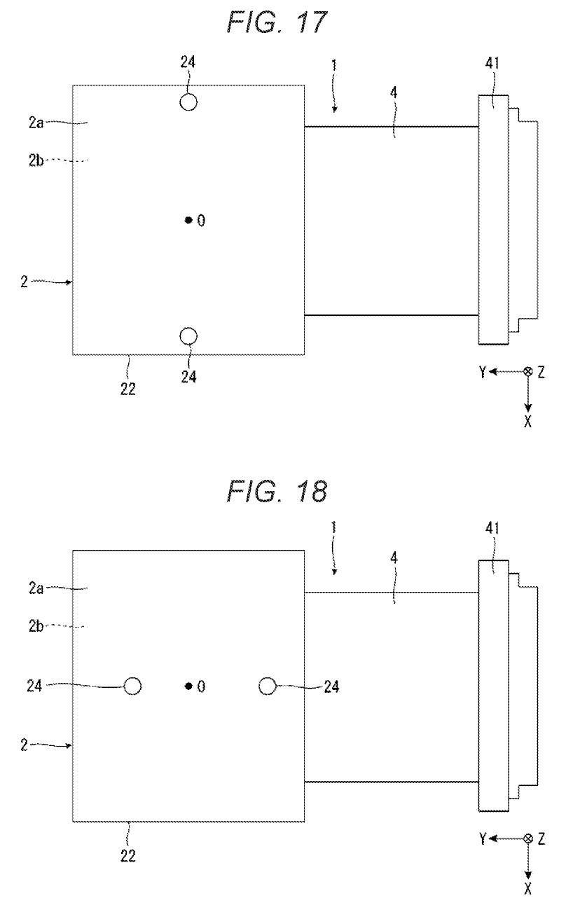

FIG. 15 is a perspective view of a sensor module according to a fourth embodiment. FIG. 16 is a bottom view of the sensor module. FIGS. 17 and 18 are respectively bottom views showing modifications of the sensor module.

The sensor module 1 of the present embodiment is the same as that of the first embodiment described above except that the configuration of the package 2 is different. In the following description, the present embodiment will be described with a focus on the differences from the above-described first embodiment, and the description of the same matters will be omitted. In the respective drawings of the present embodiment, the same configurations as those in the above-described embodiment have the same signs.

As shown in FIG. 15, in the sensor module 1 of the present embodiment, the package 2 has a plurality of first screw insertion holes 24. Further, although not illustrated, the circuit substrate 92 of the mounting board 91 is formed with a plurality of screw holes 921 for fastening the screws N1 inserted into the respective first screw insertion holes 24. As described above, since the package 2 has the plurality of first screw insertion holes 24, the sensor module 1 can be mounted on the mounting board 91 using the plurality of screws N1, and thus the mounting stability of the sensor module 1 is increased.

In particular, in the present embodiment, as shown in FIG. 16, the package 2 has two first screw insertion holes 24 disposed to face each other via the center O of the lower surface 2a. In other words, the package 2 has two first screw insertion holes 24 located at opposite sides with respect to the center O of the lower surface 2a. By disposing the two first screw insertion holes 24 in the positional relationship, the two first screw insertion holes 24 can be separated as much as possible, and thus the mounting stability of the sensor module 1 is further increased.

In the present embodiment, the two first screw insertion holes 24 are arranged along the diagonal direction of the lower surface 2a, but the arrangement of the first screw insertion holes 24 is not limited thereto. For example, the holes may be arranged along the X-axis direction as shown in FIG. 17, or may be arranged along the Y-axis direction as shown in FIG. 18. The number of the first screw insertion holes 24 is not limited to two, but may be three or more.

As described above, in the sensor module 1 of the present embodiment, the package 2 has the plurality of first screw insertion holes 24. According to the configuration, the mounting stability of the sensor module 1 is further increased.

As described above, the package 2 has the pair of first screw insertion holes 24 disposed to face each other via the center O of the lower surface 2a.

According to the fourth embodiment, the same effects as those of the above described first embodiment can be exerted.

### Fifth Embodiment

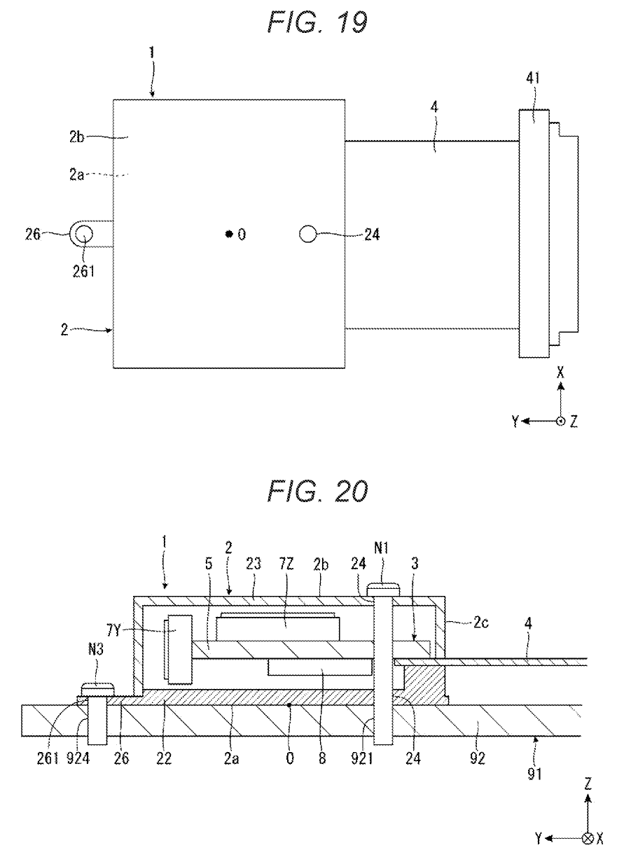

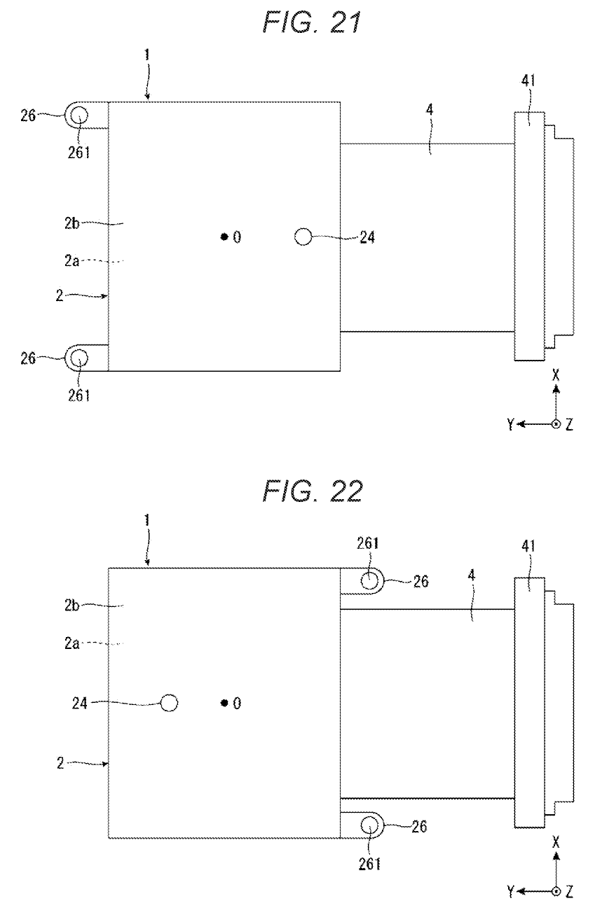

FIG. 19 is a top view showing a sensor module according to a fifth embodiment. FIG. 20 is a cross-sectional view of the sensor module. FIG. 21 is a top view showing a modification of the sensor module.

The sensor module 1 of the present embodiment is the same as that of the first embodiment described above except that the configuration of the package 2 is different. In the following description, the present embodiment will be described with a focus on the differences from the above-described first embodiment, and the description of the same matters will be omitted. In the respective drawings of the present embodiment, the same configurations as those in the above-described embodiment have the same signs.

As shown in FIGS. 19 and 20, in the sensor module 1 of the present embodiment, the first screw insertion hole 24 is located at the negative side in the Y-axis direction with respect to the center O. Further, the package 2 includes a fixing portion 26 extending from the main body portion 20 toward the positive side in the Y-axis direction along the lower surface 2a. That is, the fixing portion 26 is disposed at the side opposite to the flexible wiring portion 4 with respect to the main body portion 20. A third screw insertion hole 261 through which a screw N3 is inserted is formed in the fixing portion 26. As will be described later, the fixing portion 26 is fixed to the mounting board 91 by the screw N3 inserted through the third screw insertion hole 261. Further, the circuit substrate 92 of the mounting board 91 is formed with a screw hole 924 for fastening the screw N3 inserted into the third screw insertion hole 261.

The sensor module 1 having the configuration is fixed to the circuit substrate 92 by fastening the screw N1 inserted through the first screw insertion hole 24 to the screw hole 921 and fastening the screw N3 inserted through the third screw insertion hole 261 to the screw hole 924. As described above, by mounting the sensor module 1 on the mounting board 91 using the two screws N1 and N3, the mounting stability of the sensor module 1 is increased. In particular, since the fixing portion 26 is disposed at the side opposite to the flexible wiring portion 4 with respect to the main body portion 20, two points located at both ends among the three fixing points (the connector 41, the screw N1, and the screw N3), that is, the connector 41 and the screw N3 can be separated as much as possible. Therefore, the mounting stability of the sensor module 1 is increased.

As described above, in the sensor module 1 of the present embodiment, the package 2 includes the fixing portion 26 extending out from the main body portion 20 along the lower surface 2a and fixed to the mounting board 91. According to the configuration, the mounting stability of the sensor module 1 is increased.

As described above, in the plan view of the lower surface 2a, the fixing portion 26 is disposed at the side opposite to the flexible wiring portion 4 with respect to the main body portion 20. According to the configuration, the mounting stability of the sensor module 1 is increased.

According to the fifth embodiment, the same effects as those of the above-described first embodiment can be exerted. However, the configuration of the sensor module 1 is not particularly limited, and for example, as illustrated in FIG. 21, a pair of the fixing portions 26 may be arranged along the X-axis direction.

### Sixth Embodiment

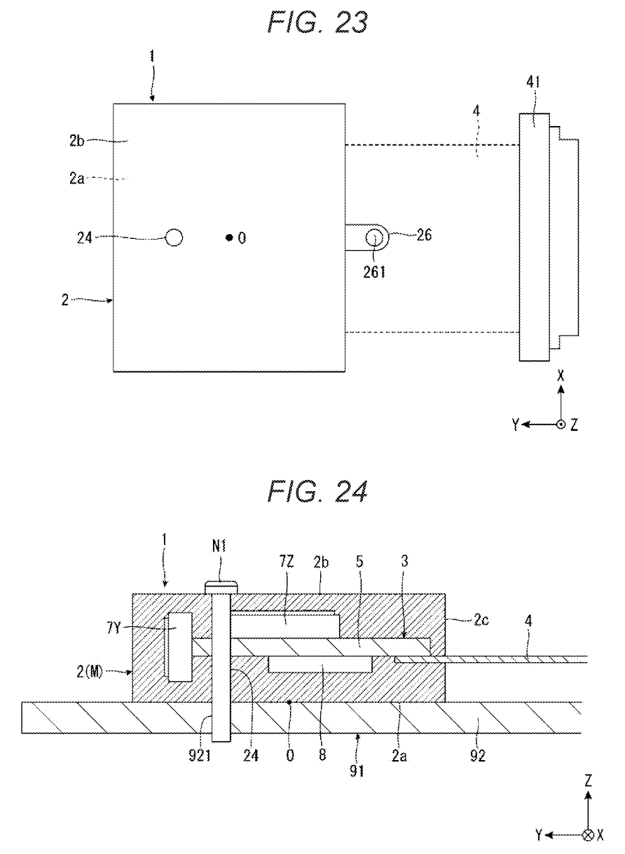

FIG. 22 is a top view of a sensor module according to a sixth embodiment. FIG. 23 is a top view showing a modification of the sensor module.

The sensor module 1 of the present embodiment is the same as that of the first embodiment described above except that the configuration of the package 2 is different. In the following description, the present embodiment will be described with a focus on the differences from the above-described first embodiment, and the description of the same matters will be omitted. In the respective drawings of the present embodiment, the same configurations as those in the above-described embodiment have the same signs.

As illustrated in FIG. 22, in the sensor module 1 of the present embodiment, the package 2 includes a pair of fixing portions 26 extending out from the main body portion 20 toward the negative side in the Y-axis direction along the lower surface 2a. That is, the pair of fixing portions 26 are disposed at the same side as the flexible wiring portion 4 with respect to the main body portion 20. The pair of fixing portions 26 are arranged side by side in the X-axis direction. Further, in a plan view from the Z-axis direction, the pair of fixing portions 26 are disposed so as to be located at both sides of the flexible wiring portion 4, and do not overlap the flexible wiring portion 4. Therefore, the screw N3 is easily inserted into the third screw insertion hole 261 formed in each fixing portion 26. According to the configuration, since the sensor module 1 is fixed to the mounting board 91 by the two screws N3 in addition to the one screw N1, the mounting stability of the sensor module 1 is increased.

As described above, in the sensor module 1 of the present embodiment, in the plan view of the lower surface 2a, the pair of fixing portions 26 are disposed so as to be located at the same side as the flexible wiring portion 4 with respect to the main body portion 20 and located at both sides of the flexible wiring portion 4. According to the configuration, the mounting stability of the sensor module 1 is increased.

According to the sixth embodiment, the same effects as those of the above-described first embodiment can be exerted. The configuration of the sensor module 1 is not particularly limited, and for example, as illustrated in FIG. 23, one fixing portion 26 may be disposed so as to overlap the flexible wiring portion 4.

As above, the sensor module of the present disclosure is described based on the illustrated embodiments, however, the present disclosure is not limited thereto. The configuration of each unit can be replaced with any configuration having the same function. Further, any other configuration may be added to the present disclosure. Furthermore, the respective embodiments may be appropriately combined.

For example, as shown in FIG. 24, the package 2 may be formed using a resin mold M.

What is claimed is:

1. A sensor module comprising:
a sensor substrate including a circuit substrate and an inertial sensor mounted on the circuit substrate;
a package including a main body portion having a first surface and a second surface in a front-back relationship and a side surface coupling the first surface and the second surface and housing the sensor substrate inside; and
a flexible wiring portion electrically coupled to the sensor substrate and extending from the side surface to an outside of the package, wherein
the package has a first screw insertion hole penetrating the first surface and the second surface, and is fixed to an object by a screw inserted through the first screw insertion hole.

2. The sensor module according to claim 1, wherein
the circuit substrate and the flexible wiring portion are formed using a rigid flexible substrate including a rigid substrate as the circuit substrate and a flexible substrate as the flexible wiring portion.

3. The sensor module according to claim 1, wherein
the first screw insertion hole is disposed at a side opposite to the flexible wiring portion with respect to a center of the first surface in a plan view of the first surface.

4. The sensor module according to claim 1, wherein
the package has a plurality of the first screw insertion holes.

5. The sensor module according to claim 4, wherein
the package has a pair of the first screw insertion holes disposed to face each other via a center of the first surface.

6. The sensor module according to claim 1, wherein
the flexible wiring portion has a second screw insertion hole and is fixed to the object by a screw inserted through the second screw insertion hole.

7. The sensor module according to claim 1, wherein
the package includes a fixing portion that extends out from the main body portion along the first surface and is fixed to the object.

8. The sensor module according to claim 7, wherein
the fixing portion is disposed at a side opposite to the flexible wiring portion with respect to the main body portion in a plan view of the first surface.

9. The sensor module according to claim 7, wherein
a pair of the fixing portions are disposed so as to be located at a same side as the flexible wiring portion with respect to the main body portion and located at both sides of the flexible wiring portion in a plan view of the first surface.

10. The sensor module according to claim 1, wherein
the package includes a convex portion protruding from the first surface, and the convex portion engages with the object.
